(19) United States
(12) Patent Application Publication
(10) Pub. No.: US 2008/0041610 A1
(43) Pub. Date: Feb. 21, 2008

(54) Conducting cord that can resist static electricity and electromagnetic waves

(76) Inventor: Chih-Fang Cheng, Sindian City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/504,813

(22) Filed: Aug. 15, 2006

(51) Int. Cl. H01B 7/08

(52) U.S. Cl. 174/117 F

(57) ABSTRACT

A conducting cord includes an outer layer, an aluminum foil layer mounted in the outer layer, an insulating layer mounted in the aluminum foil layer, a signal line module mounted in the insulating layer, and at least one ground wire mounted in the aluminum foil layer. When the signal lines produce a static electricity, the static electricity is conducted through the electrically conducting inner face of the aluminum foil layer into the ground wire and is conducted outwardly from the ground wire. Thus, when the conducting cord is placed in a computer, the conducting cord will not produce an electromagnetic wave to prevent the electromagnetic wave from damaging other electronic parts of the computer.

### BACKGROUND OF THE INVENTION

1. Field of the Invention

The present invention relates to a conducting cord and, more particularly, to a conducting cord for an electronic equipment, such as the computer or the like.

2. Description of the Related Art

A computer comprises multiple conducting cords to transmit a signal or to supply an electric power. Each of the conducting cords contains a plurality of signal lines to transmit the signal. However, the electromagnetic waves produced between the signal lines of each of the conducting cords easily damage other electronic parts of the computer, thereby causing inconvenience to a user when operating the computer.

### BRIEF SUMMARY OF THE INVENTION

In accordance with the present invention, there is provided a conducting cord, comprising an outer layer, an aluminum foil layer mounted in the outer layer, an insulating layer mounted in the aluminum foil layer, a signal line module mounted in the insulating layer, and at least one ground wire mounted in the aluminum foil layer.

The primary objective of the present invention is to provide a conducting cord that can resist static electricity and electromagnetic waves.

Another objective of the present invention is to provide a conducting cord, wherein when the signal lines produce a static electricity, the static electricity is conducted through the electrically conducting inner face of the aluminum foil layer into the ground wire and is conducted outwardly from the ground wire.

A further objective of the present invention is to provide a conducting cord, wherein when the conducting cord is placed in a computer, the conducting cord will not produce an electromagnetic wave to prevent the electromagnetic wave from damaging other electronic parts of the computer.

A further objective of the present invention is to provide a conducting cord, wherein the conducting cord has a simplified construction so that the conducting cord is operated efficiently to enhance the working efficiency of the computer.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a partially cut-away perspective view of a conducting cord in accordance with the preferred embodiment of the present invention.

FIG. 2 is a side plan cross-sectional view of the conducting cord as shown in FIG. 1.

FIG. 3 is a side plan cross-sectional view of a conducting cord in accordance with another preferred embodiment of the present invention.

### DETAILED DESCRIPTION OF THE INVENTION

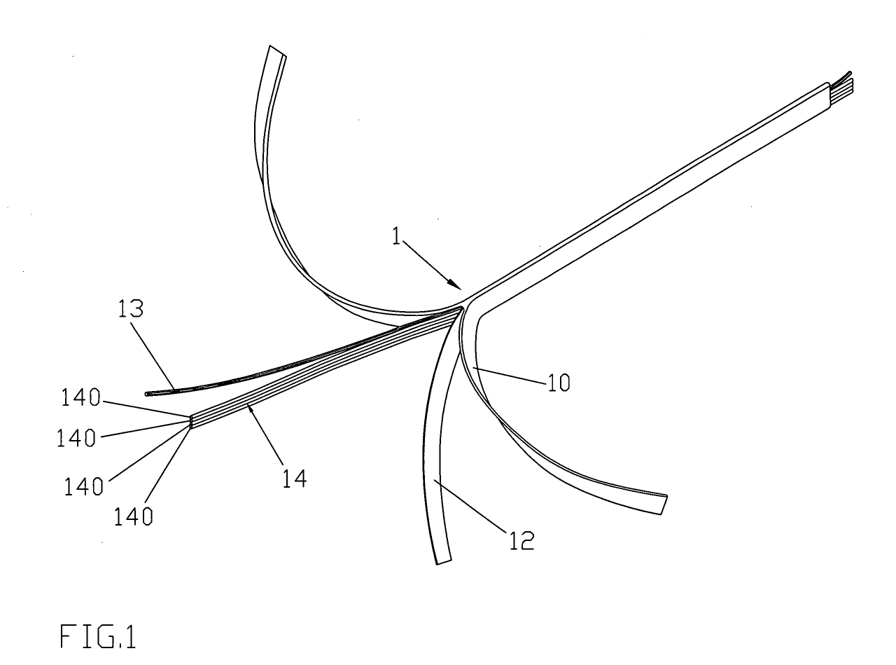

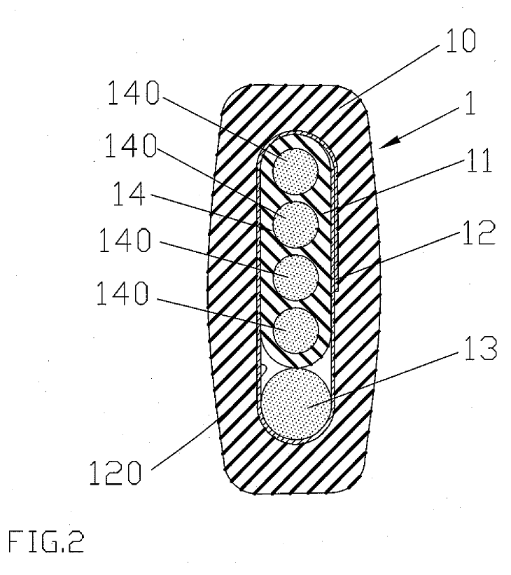

Referring to the drawings and initially to FIGS. 1 and 2, a conducting cord 1 in accordance with the preferred embodiment of the present invention comprises an outer layer 10, an aluminum foil layer 12 mounted in the outer layer 10, an insulating layer 11 mounted in the aluminum foil layer 12, a signal line module 14 mounted in the insulating layer 11, and at least one ground wire 13 mounted in the aluminum foil layer 12.

In the preferred embodiment of the present invention, the conducting cord 1 comprises a ground wire 13 mounted in the aluminum foil layer 12 and contacting with the insulating layer 11.

The outer layer 10 is made of plastic material and encompasses a periphery of the aluminum foil layer 12 to separate the signal line module 14 from the ambient environment.

The signal line module 14 includes a plurality of single signal lines 140 located in parallel with each other. Each of the signal lines 140 of the signal line module 14 is extruded to have a flattened strip shape.

The insulating layer 11 encompasses a periphery of each of the signal lines 140 of the signal line module 14, so that the signal lines 140 of the signal line module 14 are separated from each other by the insulating layer 11 to prevent the signal lines 140 from interfering with each other.

The aluminum foil layer 12 encompasses a periphery of the insulating layer 11 and the ground wire 13 to bind the insulating layer 11 and the ground wire 13 together. The aluminum foil layer 12 has an electrically conducting inner face 120 connected between the insulating layer 11 and the ground wire 13, so that when the signal lines 140 of the signal line module 14 produce a static electricity, the static electricity is conducted through the electrically conducting inner face 120 of the aluminum foil layer 12 into the ground wire 13 and is conducted outwardly from the ground wire 13. Thus, when the conducting cord 1 is placed in a computer, the conducting cord 1 will not produce an electromagnetic wave to prevent the electromagnetic wave from damaging other electronic parts of the computer.

Accordingly, when the signal lines 140 of the signal line module 14 produce a static electricity, the static electricity is conducted through the electrically conducting inner face 120 of the aluminum foil layer 12 into the ground wire 13 and is conducted outwardly from the ground wire 13. In addition, when the conducting cord 1 is placed in a computer, the conducting cord 1 will not produce an electromagnetic wave to prevent the electromagnetic wave from damaging other electronic parts of the computer. Further, the conducting cord 1 has a simplified construction so that the conducting cord 1 is operated efficiently to enhance the working efficiency of the computer.

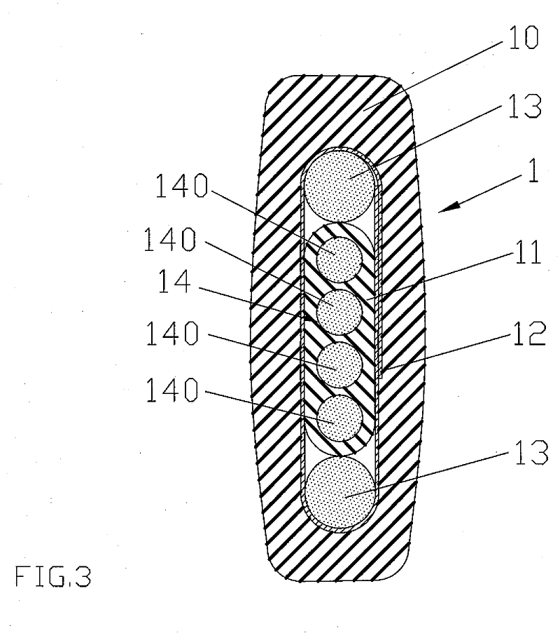

Referring to FIG. 3, the conducting cord 1 comprises two spaced ground wires 13 mounted in the aluminum foil layer 12 and contacting with the insulating layer 11. The two ground wires 13 are located at and contacting with two opposite sides of the insulating layer 11.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A conducting cord, comprising;
an outer layer;
an aluminum foil layer mounted in the outer layer;
an insulating layer mounted in the aluminum foil layer;
a signal line module mounted in the insulating layer;
at least one ground wire mounted in the aluminum foil wherein
the signal line module includes a plurality of single signal lines;
each of the signal lines of the signal line module is extruded to have a flattened strip shape;
the insulating layer encompasses a periphery of each of the signal lines of the signal line module;
the aluminum foil layer encompasses a periphery of the insulating layer and a periphery of the ground wire to bind the insulating layer and the ground wire together.

2. The conducting cord in accordance with claim 1, wherein the conducting cord comprises a ground wire contacting with the insulating layer.

3. The conducting cord in accordance with claim 1, wherein the outer layer is made of plastic material.

4. The conducting cord in accordance with claim 1, wherein the outer layer encompasses a smooth periphery of the aluminum foil layer to separate the signal line module from an ambient environment.

5. (canceled)

6. The conducting cord in accordance with claim 1, wherein the signal lines of the signal line are located in parallel with each other and are spaced from each other.

7. (canceled)

8. (canceled)

9. The conducting cord in accordance with claim 1, wherein the signal lines of the signal line module are spaced and separated from each other by the insulating layer to prevent the signal lines from interfering with each other.

10. (canceled)

11. The conducting cord in accordance with claim 1, wherein the aluminum foil layer has an electrically conducting inner face having a smooth shape and connected between the insulating layer and the ground wire.

12. The conducting cord in accordance with claim 11, wherein when the signal line module produce a static electricity, the static electricity is conducted through the electrically conducting inner face of the aluminum foil layer into the ground wire and is conducted outwardly from the ground wire.

13. The conducting cord in accordance with claim 1, wherein the conducting cord comprises two spaced ground wires contacting with the insulating layer.

14. The conducting cord in accordance with claim 13, wherein the two ground wires are located at two opposite sides of the insulating layer

15. The conducting cord in accordance with claim 1, wherein the insulating layer encompasses all of the signal lines of the signal line module, and the aluminum foil layer encompasses the insulating layer so that the insulating layer is located between the aluminum foil layer and all of the signal lines of the signal line module to prevent the aluminum foil layer from contacting the signal lines of the signal line module directly.

16. The conducting cord in accordance with claim 1, wherein the insulating layer encompasses and binds all of the signal lines of the signal line module simultaneously.

17. The conducting cord in accordance with claim 16, wherein the aluminum foil layer encompasses the insulating layer and all of the signal lines of the signal line module simultaneously.
